(19) United States
(12) Patent Application Publication
(10) Pub. No.: US 2018/0274391 A1
(43) Pub. Date: Sep. 27, 2018

(54) SYSTEMS AND METHODS FOR OPERATING A COMBINED CYCLE POWER PLANT

(71) Applicant: General Electric Company, Schenectady, NY (US)

(72) Inventors: George Vargese Mathai, Atlanta, GA (US); Jeremy Andrew Williams, Jupiter, FL (US); Joseph Klosinski, Atlanta, GA (US); Sanji Ekanayake, Atlanta, GA (US); William Fisher, Atlanta, GA (US); Alston Scipio, Atlanta, GA (US)

(21) Appl. No.: 15/464,955

(22) Filed: Mar. 21, 2017

(51) Int. Cl. F01K 23/10; F02C 6/18; H02K 7/18; F02C 3/04; F02C 9/50

(52) U.S. Cl. CPC F01K 23/101; F02C 6/18; F02C 9/50; F02C 3/04; H02K 7/1823

(57) ABSTRACT

Embodiments of systems and methods described in this disclosure are directed to operating a combined cycle power plant. In certain embodiments, systems and methods can be provided for a combined cycle power plant incorporating a control system that uses a holistic approach to continuously and automatically adjust a heat rate of the combined cycle power plant and achieve a desired efficiency. In accordance with one embodiment of the disclosure, the control system can be used to dynamically control various operations of the combined cycle power plant, including addressing of certain conflicting requirements such as avoiding generation of superheated steam in an attemperator while concurrently maintaining exhaust emissions within allowable regulatory limits and maintaining exhaust gas temperatures within allowable material capability limits. The use of such a control system allows for an increased turndown capability of the combined cycle power plant along with an improvement in a combined cycle heat rate of the combined cycle power plant.

### FIELD OF THE DISCLOSURE

This disclosure relates to power plants, and more particularly, to systems and methods for operating a combined cycle power plant.

### BACKGROUND OF THE DISCLOSURE

A combined cycle power plant typically includes a gas turbine, a heat recovery system, and a steam turbine. The gas turbine burns a compressed air-fuel mixture that is moved past turbine blades in the gas turbine to make the turbine blades spin. Movement of the turbine blades causes a shaft of the gas turbine to rotate, which in turn drives a generator that generates electricity. The heat recovery system captures exhaust heat from the gas turbine and creates steam that is delivered to a steam turbine. The steam turbine drives the generator to produce additional electricity.

The amount of electricity generated by the combined cycle power plant can be varied in accordance with the amount of electricity drawn by what is referred to as a load. The term “load” refers to various types of elements such as household appliances and commercial/industrial equipment that operate using electricity provided by the combined cycle power plant. Typically, the amount of electricity provided by the combined cycle power plant closely tracks the load. However, for various reasons, it is impractical to vary the operation of the gas turbine and/or the steam turbine too often and/or too rapidly. Consequently, in several traditional systems, an operational balance is struck by adjusting certain operations of the combined cycle power plant, for example, by modifying an operation of the heat recovery system.

However, adjusting the operation of the heat recovery system can be a difficult procedure in view of conflicting requirements such as avoiding generation of superheated steam while concurrently preventing exhaust emissions from the gas turbine from exceeding allowable regulatory limits and preventing exhaust gas temperature from the gas turbine from exceeding allowable heat recovery steam generator material capability limits. Traditionally, such adjustments have been carried out by using empirical data and sub-optimal configurations. One example of a sub-optimal configuration can include monitoring various parameters of the gas turbine (such as air flow rate and exhaust temperature) and of the heat recovery system (such as steam temperature, water flow rate etc.) in an independent manner and adjusting these parameters without taking into consideration adverse effects such actions may have upon the operations of some other components of the combined cycle power plant.

### BRIEF DESCRIPTION OF THE DISCLOSURE

Embodiments of the disclosure are directed generally to systems and methods for operating a combined cycle power plant. In certain embodiments, systems and methods can be provided for automatically configuring a combined cycle power plant to operate relatively efficiently.

According to one exemplary embodiment of the disclosure, a combined cycle power plant can include a gas turbine, a heat recovery steam generator, a steam turbine, and a control system. The heat recovery steam generator is coupled to the gas turbine and includes an attemperator that dispenses a fluid at a spray rate determined by a loading condition of the combined cycle power plant. The steam turbine is coupled to the heat recovery steam generator and is configured to receive steam generated in the heat recovery steam generator. The control system is configured to detect the spray rate and to automatically adjust a heat rate of the combined cycle power plant, via adjustment of gas turbine air flow rate and exhaust temperature within allowable limitations, in accordance with the spray rate and the loading condition of the combined cycle power plant.

According to another exemplary embodiment of the disclosure, a method of operating a combined cycle power plant includes detecting a first spray rate of a fluid in an attemperator when the combined cycle power plant is operating under a full load condition; operating a control system to set a first heat rate of the combined cycle power plant in accordance with the first spray rate, the first heat rate and the first spray rate allowing the combined cycle power plant to operate in the full load condition and within operating specifications of the combined cycle power plant; detecting a second spray rate of the fluid in the attemperator when the combined cycle power plant is operating under a full turndown condition; and operating the control system to automatically change the first heat rate of the combined cycle power plant to at least a second heat rate, the second heat rate and the second spray rate allowing the combined cycle power plant to operate in the full turndown condition and within operating specifications of the combined cycle power plant.

According to yet another exemplary embodiment of the disclosure, a non-transitory computer-readable storage medium contains instructions executable by at least one computer for performing operations that include detecting a first spray rate of a fluid in an attemperator when a combined cycle power plant is operating under a full load condition; operating a control system to set a first heat rate of the combined cycle power plant in accordance with the first spray rate, the first heat rate and the first spray rate allowing the combined cycle power plant to operate under the full load condition and within operating specifications of the combined cycle power plant; detecting at least a second spray rate of the fluid in the attemperator when the combined cycle power plant is operating under a full turndown condition; and operating the control system to automatically change the first heat rate of the combined cycle power plant to at least a second heat rate, the second heat rate and the second spray rate allowing the combined cycle power plant to operate under the full turndown condition with no interruption and within operating specifications of the combined cycle power plant.

Other embodiments and aspects of the disclosure will become apparent from the following description taken in conjunction with the following drawings.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates a combined cycle power plant that includes a control system for automatically controlling various elements of the combined cycle power plant in accordance with an exemplary embodiment of the disclosure.

FIG. 2 illustrates some example components of a gas turbine and a heat recovery steam generator that can be part of the combined cycle power plant shown in FIG. 1.

FIG. 3 illustrates some additional example components of the combined cycle power plant shown in FIG. 1.

FIG. 4 shows an example graphical representation that illustrates a relationship between electrical power output and allowable exhaust temperatures of an example gas turbine that can be part of the combined cycle power plant shown in FIG. 1.

FIG. 5 shows an example graphical representation that illustrates a difference between a traditional control configuration and a model-based control configuration that is in accordance with an exemplary embodiment of the disclosure.

FIG. 6 illustrates an exemplary implementation of the control system shown in FIG. 1.

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein; rather, these embodiments are provided so that this disclosure will satisfy applicable legal requirements. Like numbers refer to like elements throughout. It should be understood that certain words and terms are used herein solely for convenience and such words and terms should be interpreted as referring to various objects and actions that are generally understood in various forms and equivalencies by persons of ordinary skill in the art. For example, the words “heat rate” as used herein pertains to a measure of system efficiency in a power plant such as the combined cycle power plant referred to in this disclosure. The heat rate (typically in Btu/kWh) can be generally defined as an amount of energy provided to a system (typically in MBtu/h) divided by the amount of electricity generated (typically in kW). Efficiency is simply the inverse of the heat rate. Consequently, it can be understood that the efficiency of a power plant can be increased by lowering the heat rate. As another example, the word “example” as used herein is intended to be non-exclusionary and non-limiting in nature. More particularly, the word “exemplary” as used herein indicates one among several examples, and it should be understood that no undue emphasis or preference is being directed to the particular example being described.

### DETAILED DESCRIPTION OF THE DISCLOSURE

In terms of a general overview, certain embodiments of the systems and methods described in this disclosure are directed to systems and methods for operating a combined cycle power plant. Certain embodiments of the disclosure are directed to a combined cycle power plant incorporating a control system that uses a holistic approach to continuously and automatically adjust a heat rate of the combined cycle power plant to operate relatively efficiently. In accordance with one embodiment of the disclosure, the control system can be used to dynamically control various operations of the combined cycle power plant, such as control of gas turbine air flow rate and exhaust temperature, in order to address certain conflicting requirements such as avoiding generation of saturated steam in a steam line while concurrently maintaining exhaust emissions and gases within allowable regulatory and material capability limits. The use of such a control system allows for an increased turndown capability of the combined cycle power plant along with an improvement in a combined cycle heat rate of the combined cycle power plant.

It should be understood that in contrast to the systems and methods described in this disclosure, many traditional systems carry out adjustments by either using empirical data or sub-optimal configurations. One example of a sub-optimal configuration can include monitoring various parameters of a heat recovery system (such as steam temperature, water flow rate etc.) in an independent manner and adjusting these parameters without taking into consideration adverse effects such actions may have upon the operations of some other components of the combined cycle power plant. In some other cases, a feedwater spray of an attemperator in the heat recovery system may be unable to provide an adequate amount of water (or may provide feedwater too close to the saturation limit of steam) when the combined cycle heat rate is operating under a partial load condition. Manual intervention may be needed in order to address this condition, which can be detrimental to the operation of a combined cycle power plant.

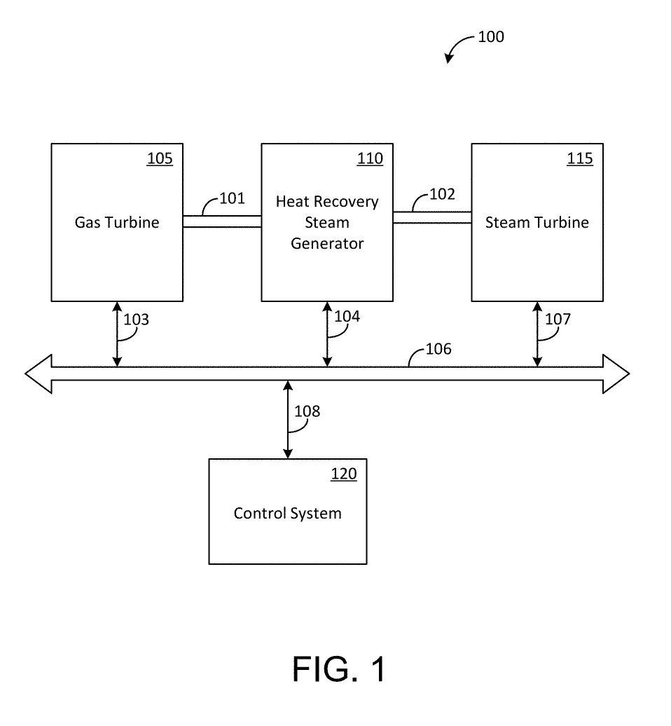

Turning to FIG. 1, a combined cycle power plant 100 is shown that includes a control system 120 for integrated control of various elements of the combined cycle power plant 100 in accordance with an exemplary embodiment of the disclosure. The various elements of the combined cycle power plant 100 can include a gas turbine 105, a heat recovery steam generator 110, a steam turbine 115, and a control system 120. When in operation, the gas turbine 105 burns a compressed air-fuel mixture that is moved past turbine blades in the gas turbine 105 in order to make the turbine blades rotate or otherwise move about a shaft or axis. The rotation or movement of the turbine blades causes a shaft (not shown) of the gas turbine 105 to rotate, which in turn drives a generator (not shown) that generates electricity.

Exhaust gases from the gas turbine 105 are delivered through a conduit 101 to the heat recovery steam generator 110. The heat recovery steam generator 110 generates steam that is delivered through a conduit 102 to the steam turbine 115. An attemperator (not shown) is used for temperature control in the heat recovery steam generator 110. The steam generated by the heat recovery steam generator 110 is used to operate the steam turbine 115 and generate additional electricity (in addition to the electricity generated by the generator in the gas turbine 105).

In accordance with this exemplary embodiment, the control system 120 is communicatively coupled to at least the gas turbine 105, the heat recovery steam generator 110, and the steam turbine 115 via a communication network that can include a bus 106 and several links. In other embodiments, other non-bus oriented communication networks can be used. The various links, some of which can be unidirectional and others bidirectional in nature can carry various types of signals and/or data. For example, various sensors located in the gas turbine 105 can provide data pertaining to various conditions present in the gas turbine 105 when the combined cycle power plant 100 is in operation. For example, one or more temperature sensors can provide thermal data pertaining to temperature levels in various parts of the gas turbine 105, one or more pressure sensors can provide pressure-related data in various parts of the gas turbine 105, one or more speed sensors can provide speed-related data of various components of the gas turbine 105, and so on. The data provided by the sensors in the gas turbine 105 can be conveyed to the control system 120 via the link 103, the bus 106, and the link 108. It should be understood that the link 103 shown in FIG. 1 pictorially represents several data-carrying links, several control signal links, and/or communication links. The control system 120 can use the sensor data to generate one or more control signals that are conveyed in the opposite direction via the link 108, the bus 106, and the link 103, to the gas turbine 105 for controlling certain elements in the gas turbine 105. For example, a temperature-related control signal can be provided to a fuel control system in the gas turbine 105 so as to reduce an amount of air-fuel mixture injected into the gas turbine 105, thereby modifying the exhaust gas temperature in the gas turbine 105.

Similarly, various sensors located in the heat recovery steam generator 110 can provide data pertaining to various conditions present in the heat recovery steam generator 110 when the combined cycle power plant 100 is in operation. For example, one or more temperature sensors can provide thermal data pertaining to steam generated in the heat recovery steam generator 110. The thermal data provided by the temperature sensors in the heat recovery steam generator 110 can be conveyed to the control system 120 via the link 104, the bus 106, and the link 108. It should be understood that the link 104 and the link 108 shown in FIG. 1 pictorially represent several data-carrying links, several control signal links, and/or communication links. The control system 120 can use the thermal data to generate one or more control signals that are conveyed in the opposite direction via the link 108, the bus 106, and the link 104, to the heat recovery steam generator 110 for controlling an attemperator (not shown).

Various sensors located in the steam turbine 115 can provide data pertaining to various conditions present in the steam turbine 115 when the combined cycle power plant 100 is in operation. For example, one or more speed sensors can provide speed-related data pertaining to a rotation speed of the steam turbine 115. The speed-related data provided by the speed sensors in the steam turbine 115 can be conveyed to the control system 120 via the link 107, the bus 106, and the link 108. It should be understood that the link 107 shown in FIG. 1 pictorially represents several data-carrying links, several control signal links, and/or communication links. The control system 120 can use the speed-related data to generate a speed-related control signal that can be provided to a steam inlet valve controller in the steam turbine 115 so as to reduce an amount of steam provided to the steam turbine 115, thereby modifying a speed of rotation of the blades in the steam turbine 115.

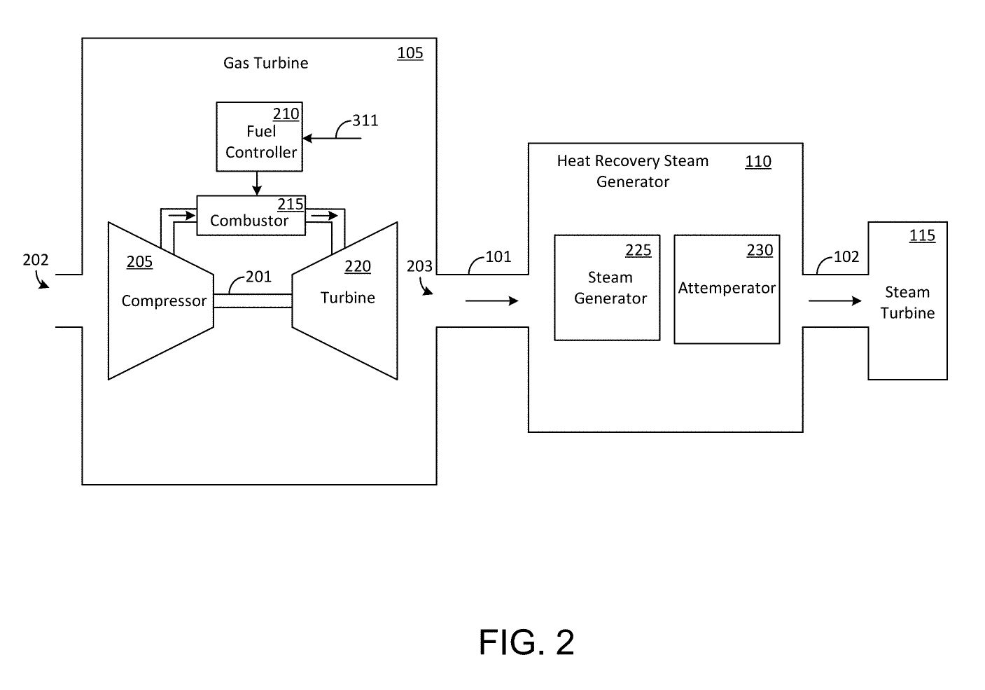

FIG. 2 illustrates some example components of the gas turbine 105 and the heat recovery steam generator 110. The example components in the gas turbine 105 can include a compressor 205 that receives atmospheric air via an intake port 202 and compresses the air to a higher pressure. The compressed air is fed into a combustor 215, where fuel provided by a fuel controller 210 is combined with the compressed air, and the air-fuel mixture ignited. The ignited air-fuel mixture generates a high-temperature gas mixture that enters the turbine 220 and expands. The expansion causes turbine blades to rotate or move, thereby rotating a rotary shaft 201. The rotation of the rotary shaft 201 not only drives the compressor 205 but also drives a generator (not shown) that is coupled to the rotary shaft 201. The electricity generated by the generator constitutes an electrical power output of the gas turbine that is coupled into a load (not shown), typically via an electric grid system. A portion of the high-temperature gas mixture that is not used for rotating or moving the turbine blades is emitted in the form of exhaust gases via an exhaust port 203 of the gas turbine 105. The exhaust gases from the exhaust port 203 are conveyed into the heat recovery steam generator 110 via the conduit 101.

The heat recovery steam generator 110 utilizes the waste heat available in the exhaust gases to generate steam at high pressure and high temperature. The generated steam is conveyed to the steam turbine 115 via the conduit 102 for operating the steam turbine 115. The heat recovery steam generator 110 can include various components such as a steam generator 225 and an attemperator 230. The steam generator 225 can include various elements such as a pre-heater, an evaporator, an economizer, a re-heater, and a super-heater. More than one of these elements can be incorporated into the steam generator 225. The evaporator can be used to vaporize water for producing steam and can include several drums for allowing water to interact with the exhaust gases provided by the gas turbine 105. The economizer can be used to preheat water (also referred to as feedwater) prior to entry into the evaporators. It is desirable to prevent steam from forming in the one or more economizers. The steam generated in the evaporator is typically saturated steam and this saturated steam is provided to a super-heater for producing dry steam that is used to operate the steam turbine 115.

The super-heater section of the steam generator 225 typically includes a set of primary and secondary super-heaters. The primary and secondary super-heaters constitute two separate banks of boiler tubes that are used to heat steam to a desired temperature. This temperature determines various operating parameters such as efficiency and protection, of the steam turbine 115. Consequently, the steam temperature has to be properly controlled. Temperature control is usually achieved by admitting a fine spray of water into the steam generator 225 through the attemperator 230. The attemperator 230, which is typically located between the primary and secondary super-heaters, includes a sprayer assembly through which water is sprayed on to the steam when the temperature of the steam is to be decreased. Understandably, lowering the temperature of the steam leads to a reduction in the thermal efficiency of the heat recovery steam generator 110. Consequently, the control system 120 can be used to optimize the operation of the attemperator 230 to address this issue.

The control system 120 can be further used to control the various elements of the combined cycle power plant 100 to provide for an increased turndown capability of the combined cycle power plant 100 along with an improvement in a combined cycle heat rate generated by the combined cycle power plant 100. The turndown capability of the combined cycle power plant 100 pertains to a capability of the combined cycle power plant 100 to vary the operation of the gas turbine 105 and/or the steam turbine 115 in response to varying demands of the load coupled to the electrical grid. However, varying the operation of the gas turbine 105, by turning down the heat rate of operation of the gas turbine 105, for example, can lead to some adverse effects in the heat recovery steam generator 110 that depends upon the heat characteristics of the exhaust gases provided by the gas turbine 105 to the heat recovery steam generator 110 via the exhaust port 203 and the conduit 101.

In a traditional combined cycle power plant, the heat recovery steam generator 110 may operate autonomously to vary the spray rate of water in the attemperator 230 (for example, to compensate for the modified heat rate). In some cases, this operation can be based on a pre-determined schedule of operations that is planned ahead of time based on empirical data pertaining to load variations. The pre-determined schedule may be used to operate the gas turbine 105 and the heat recovery steam generator 110 (independent of each other) at certain times of the day, for example. When executed in this independent manner, one criterion for operating the gas turbine 105 can be emission requirements dictated by various regulatory agencies. For example, the gas turbine 105 may be configured to operate during certain times in a manner that reduces emissions to a certain level. Though this action may prove satisfactory for meeting the emission requirements, it may lead to the heat recovery steam generator 110 operating in a less than desired manner. More particularly, the attemperator 230 may continue to operate at a spray rate that does not take into consideration steam saturation and/or super-heating conditions created as a result of modifying the heat rate of the gas turbine 105 so as to operate within emission requirements.

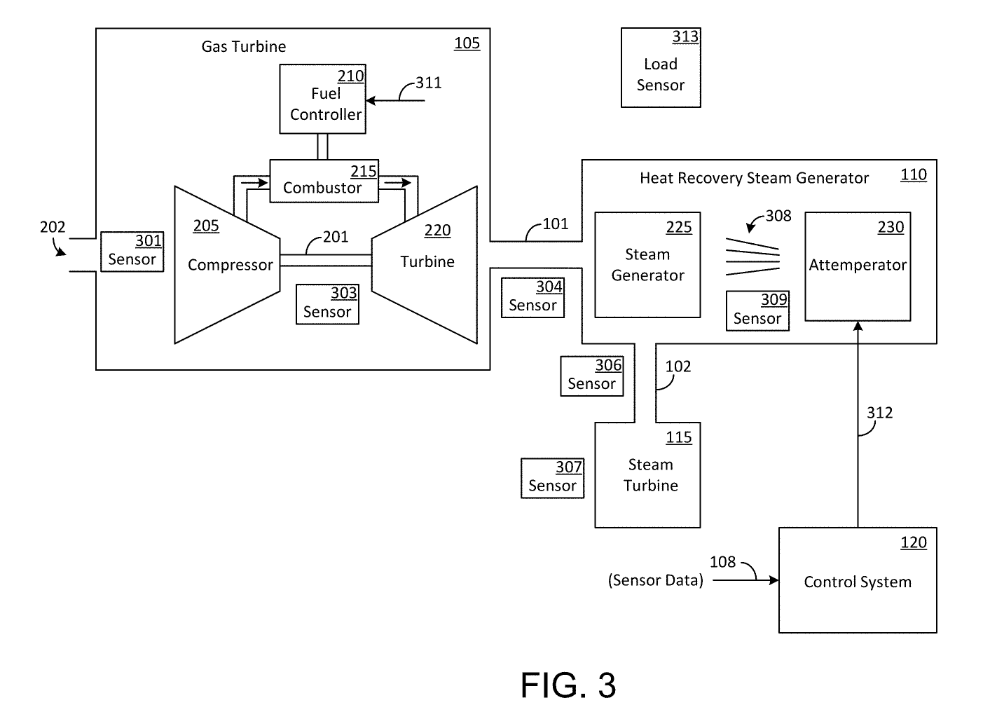

FIG. 3 illustrates some additional example components of the combined cycle power plant 100 in accordance with certain embodiments of the disclosure. The additional example components are various sensors that are located in various places for sensing various operating parameters of the combined cycle power plant 100. The information gathered by the various sensors is provided to the control system 120 in the form of sensor data that is processed by the control system 120 for generating control signals used for operating various controllers that modify the operating parameters of the combined cycle power plant 100.

Among the various sensors, the sensor 301 can be a heat sensor that monitors a temperature at the intake port 202. Sensor 303 can be a speed sensor that monitors the rotational speed of the rotary shaft 201. Sensor 304 can be a heat sensor that monitors the temperature of the exhaust gas flowing from the turbine 220 to the steam generator 225 via the conduit 101. The temperature of the exhaust gas can constitute data pertaining to the heat rate of the turbine 220 and this heat rate data can be used by the control system 120 to derive various control signals, such as a fuel control signal that is provided to the fuel controller 210 via a control link 311. The fuel controller 210 can vary the amount of fuel injected into the combustor 215 so as to modify the exhaust gas temperature and heat rate in a manner determined by the control system 120. The modification of the heat rate can be further executed by using additional sensor data such as rotational speed data provided by the sensor 303.

Sensor 306 can be a heat sensor that monitors the temperature of the steam flowing from the heat recovery steam generator 110 to the steam turbine 115 via the conduit 102. The temperature of the steam can constitute data pertaining to various conditions such as saturation and superheating and this data can be used by the control system 120 to derive various control signals, such as an attemperator control signal that is provided to the attemperator 230 via a control link 312. The attemperator control signal can be further derived using temperature data provided by a heat sensor 309 that monitors the spray rate of the spray 308 of the attemperator 230. For example, the control system 120 can detect that the spray rate is inappropriate in view of the steam being superheated and/or at saturation and can suitably tailor the attemperator control signal provided to the attemperator 230.

A load sensor 313 can be used to continuously monitor loading conditions on the gas turbine 105 and/or the steam turbine 115. The control system 120 can use load data provided by the load sensor 313 in combination with various other types of data provided by various other sensors. For example, in accordance with some embodiments of the disclosure, the control system 120 can use a holistic method to process the load data provided by the load sensor 313, the temperature data provided by the sensor 304, the temperature data provided by the sensor 306, and the spray rate data provided by the sensor 309, to generate various control signals, such as the fuel control signal that is provided to the fuel controller 210 and the attemperator control signal that is provided to the attemperator 230. This arrangement thus allows for operating parameters such as the heat rate of the gas turbine 105, the steam temperature, and/or the spray rate of the attemperator 230 to be continuously adjusted taking into consideration various interactive behaviors between elements such as the turbine 220, the steam generator 225, and the attemperator 230, thus obtaining a suitable balance between emissions requirements and power generation efficiency, for example.

Furthermore, in one example implementation, the control system 120 is configured to process data provided by the sensor 309 in the attemperator 230 to detect a first spray rate of the spray 308 over a first period of time when the combined cycle power plant 100 is operating under a full load condition. The control system 120 may determine that the first spray rate is inappropriate for obtaining a desired level of efficiency of the combined cycle power plant 100. Consequently, the control system 120 can provide one or more control signals, such as the fuel control signal that is provided to the fuel controller 210, in order to modify the exhaust gas temperature and heat rate. The adjusted heat rate can be monitored by the sensor 304 and if found inappropriate, the control system 120 can process data obtained from various other sensors such as the sensor 303, the sensor 309, and/or the sensor 306, to provide one or more additional control signals to further modify the heat rate and/or the first spray rate (without exceeding a maximum capacity of the spray 308). This procedure can be repeated in a recursive manner in a real-time mode of operation until a desired level of efficiency of the combined cycle power plant 100 is obtained. A similar procedure can be used to obtain a desired efficiency when the combined cycle power plant 100 is operating under various other loads including a full turndown condition.

The control system 120 can also be used to protect the heat recovery steam generator 110 from suffering damage as a result of improper operating conditions. For example, the control system 120 can use data obtained from the various sensors to detect an improper spray rate when the steam generator 225 is operating under a saturation condition and/or a superheated condition, and adjust the spray rate and/or other operating conditions (heat rate, steam temperature, rotational speed etc.) of the combined cycle power plant 100 to protect various components of the heat recovery steam generator 110.

Additional sensors (not shown) can be provided at various other locations for monitoring various other operating parameters and providing data to the control system 120. For example, sensors can be provided at one or more of the various stages of the compressor 205 and/or at various extraction valves in the compressor 205. Thus, data can be obtained for example, from a sensor in an extraction valve in stage 9 of the compressor 205 and from a sensor in an extraction valve in stage 13 of the compressor 205, and the control system 120 can use this data to modify the operation of the gas turbine 105 and/or other components of the combined cycle power plant 100 for achieving a desired efficiency. Modifying the operation of the gas turbine 105 can include modifying (closing, opening, partially opening etc.) of the various extraction valves, including, in some implementations, bypassing the combustor 215 and one or more sections of the turbine 220.

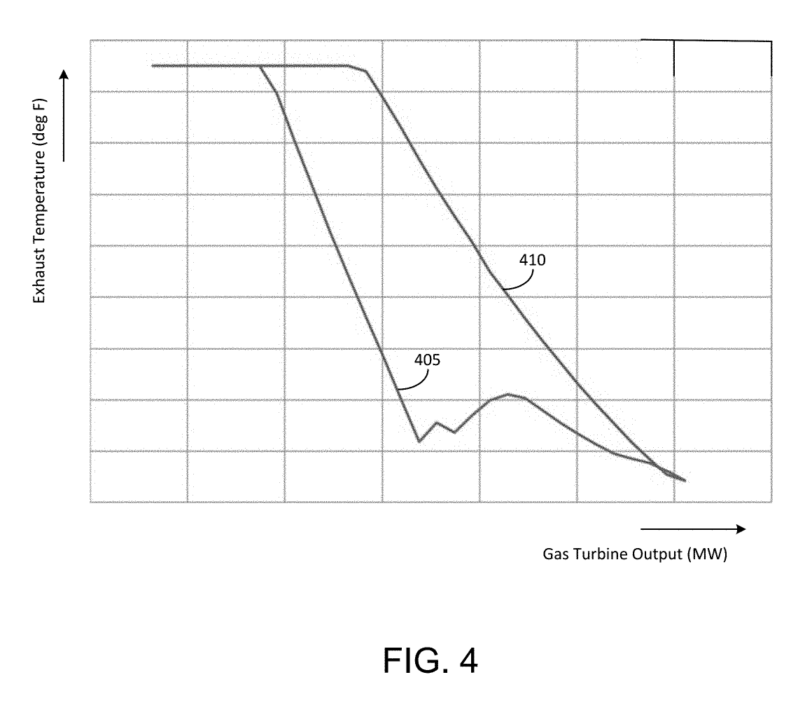

FIG. 4 shows an example graphical representation that illustrates a relationship between electrical power output and allowable exhaust temperatures of the gas turbine 105 that can be a part of the combined cycle power plant 100 in accordance with certain embodiments of the disclosure. Plot 405 indicates various minimum exhaust temperature readings versus electrical power output of the gas turbine 105 without the control system 120 providing any control actions such as would be the case in some traditional combined cycle power plants where various components are controlled independent of each other. In contrast, plot 410 indicates various maximum exhaust temperature readings versus electrical power output of the gas turbine 105 with the control system 120 providing control actions between data associated with plot 405 and data associated with plot 410 in accordance with various embodiments of this disclosure. As can be seen, the electrical power output along the sloping portion of the plot 410 is relatively higher than that provided by the plot 405 at various gas turbine power outputs, which translates to a relatively higher efficiency of operation.

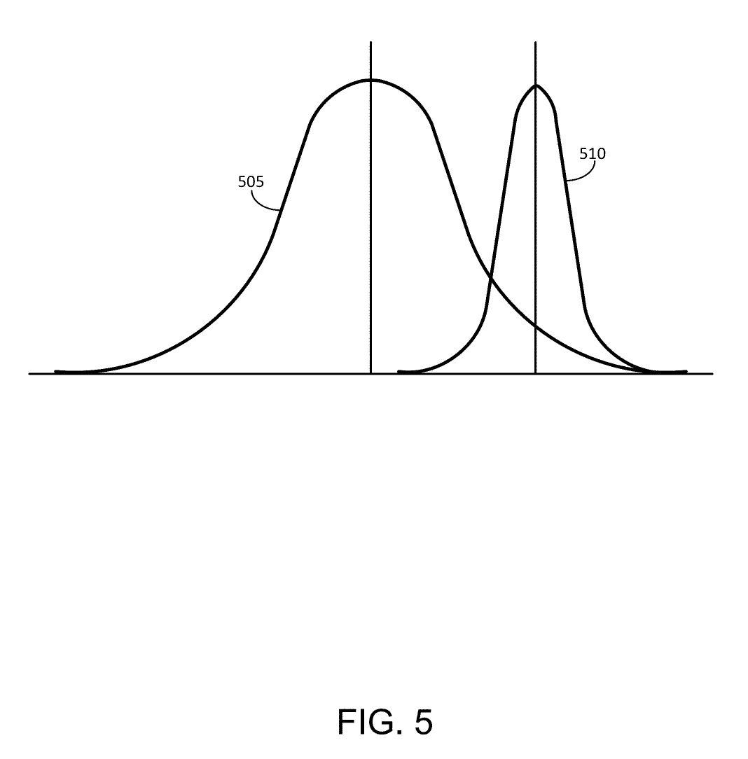

FIG. 5 shows an example graphical representation that includes a plot 505 corresponding to a traditional schedule-based control system and a plot 510 corresponding to a model-based control configuration in accordance with an exemplary embodiment of the disclosure. The traditional schedule-based control system is typically a static model that is used to set various operating parameters of a combined cycle power plant in a static manner based on a rigid schedule and pre-determined factors. Some examples of pre-determined factors can include known information pertaining to load conditions such as for example, a high load condition during the day time followed by a turndown condition during night time. As a result of this arrangement, large margins have to be used to accommodate worst case swings in one or more of the pre-determined factors, thus causing the combined cycle power plant to operate with relatively low efficiency. Furthermore, in some cases, various control actions have to be executed by human operators, which can be prone to mistakes and oversights.

On the other hand, the model-based control configuration (plot 510) that is in accordance with an exemplary embodiment of the disclosure, is a real-time, dynamic model that can be used to set various operating parameters of the combined cycle power plant 100 in a fully-automated manner in response to real-time variations in operating conditions. Various control scenarios, some of which can be based on interactions between two or more components of the combined cycle power plant 100 can be determined ahead of time and incorporated into the control system 120 such that control actions carried out by the control system 120 upon one component does not cause adverse effects on other components. The various control scenarios allow the control system 120 to operate in an autonomous manner without the need for human intervention. The narrower bell curve nature of the plot 510 is indicative of the combined cycle power plant 100 operating with desired margins at a desired efficiency.

In one example implementation of the model-based control configuration, the control system 120 obtains sensor data from the various sensors and a determination is made (either automatically or based on human input) whether to set various operating parameters of the combined cycle power plant 100 to provide a desired efficiency at a particular load or to sacrifice a certain level of efficiency in order to determine the lowest level of turndown that can satisfy emissions compliance. Accordingly, a model-based algorithm can be used in the control system 120 to set limits on various operating parameters of the combined cycle power plant 100. The various operating parameters can include one or more of the following: steam temperature, exhaust gas temperature, steam saturation point, superheat and/or reheat temperature level in the heat recovery steam generator 110, superheat and/or reheat outlet saturation point in the heat recovery steam generator 110, attemperator valve position, combustion dynamics in the gas turbine 105, and emissions levels for various exhaust gases such as nitrous oxide and carbon monoxide. The various elements that can be operated by the control system 120 for setting these various operating parameters can include the spray 308 in the attemperator 230 and various extraction valves in the gas turbine 105 (such as extraction valves in stages 9, 13 and/or 18 of the compressor 205).

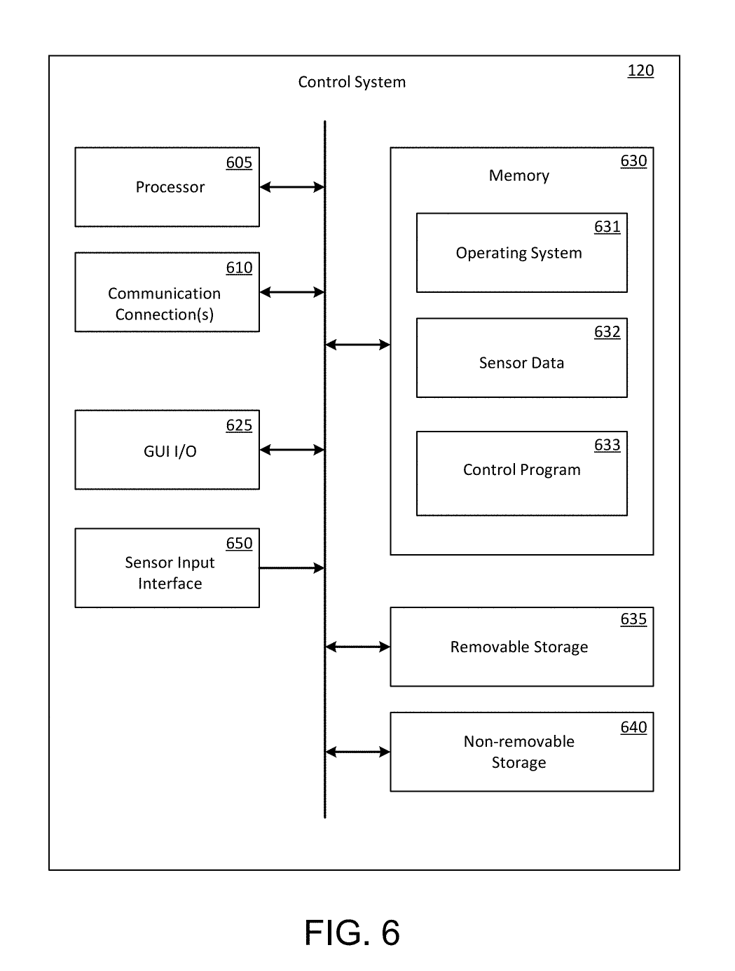

FIG. 6 illustrates an exemplary implementation of the control system 120 in accordance with an exemplary embodiment of the disclosure. In this exemplary implementation, one or more processors, such as the processor 605, can be configured to interact with a memory 630. The processor 605 can be implemented and operated using appropriate hardware, software, firmware, or combinations thereof. Software or firmware implementations can include computer-executable or machine-executable instructions written in any suitable programming language to perform the various functions described. In one embodiment, instructions associated with a function block language can be stored in the memory 630 and executed by the processor 605.

The memory 630 can be used to store program instructions that are loadable and executable by the processor 605, as well as to store data for use during the execution of these programs. Such data can include sensor data 632 obtained from the various sensors via a sensor input interface 650. Depending on the configuration and type of the control system 120, the memory 630 can be volatile (such as random access memory (RAM)) and/or non-volatile (such as read-only memory (ROM), flash memory, etc.). In some embodiments, the memory devices can also include additional removable storage 635 and/or non-removable storage 640 including, but not limited to, magnetic storage, optical disks, and/or tape storage. The disk drives and their associated computer-readable media can provide non-volatile storage of computer-readable instructions, data structures, program modules, and other data. In some implementations, the memory 630 can include multiple different types of memory, such as static random access memory (SRAM), dynamic random access memory (DRAM), or ROM.

The memory 630, the removable storage, and the non-removable storage are all examples of non-transient computer-readable storage media. Such non-transient computer-readable storage media can be implemented in any method or technology for storage of information such as computer-readable instructions, data structures, program modules or other data. Additional types of non-transient computer storage media that can be present include, but are not limited to, programmable random access memory (PRAM), SRAM, DRAM, ROM, electrically erasable programmable read-only memory (EEPROM), compact disc read-only memory (CD-ROM), digital versatile discs (DVD) or other optical storage, magnetic cassettes, magnetic tapes, magnetic disk storage or other magnetic storage devices, or any other medium which can be used to store the desired information and which can be accessed by the processor 605. Combinations of any of the above should also be included within the scope of non-transient computer-readable media.

Turning to the contents of the memory 630, the memory 630 can include, but is not limited to, an operating system (OS) 631 and one or more application programs or services for implementing the features and aspects disclosed herein. Such applications or services can include a control program 633. When executed by the processor 605, the control program 633 implements the various functionalities and features described in this disclosure.

The control system 120 can include one or more communication connections 610 that allows for communication with various devices or equipment capable of communicating with the control system 120. The connections can be established via various data communication channels or ports, such as USB or COM ports to receive connections for cables connecting the control system 120 to various other devices on a network. In one embodiment, the communication connections 610 may include Ethernet drivers that enable the control system 120 to communicate with other devices on the network. The control system 120 can also include a graphical user input/output interface 625 that allows the control system 120 to be coupled to a suitable display through which a human operator can interact with the control system 120.

Many modifications and other embodiments of the example descriptions set forth herein to which these descriptions pertain will come to mind having the benefit of the teachings presented in the foregoing descriptions and the associated drawings. Thus, it will be appreciated the disclosure may be embodied in many forms and should not be limited to the exemplary embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A combined cycle power plant comprising:
a gas turbine;
a heat recovery steam generator coupled to the gas turbine, the heat recovery steam generator comprising an attemperator that dispenses a fluid at a spray rate determined by a loading condition of the combined cycle power plant;
a steam turbine coupled to the heat recovery steam generator, the steam turbine configured to receive steam generated in the heat recovery steam generator; and
a control system configured to detect the spray rate and to automatically adjust a heat rate of the combined cycle power plant in accordance with the spray rate and the loading condition of the combined cycle power plant.

2. The combined cycle power plant of claim 1, wherein the loading condition includes a full turndown of the combined cycle power plant over a first period of time and a full loading of the combined cycle power plant over a second period of time.

3. The combined cycle power plant of claim 1, wherein the control system automatically communicates with a fuel controller in the gas turbine to modify the exhaust gas temperature and heat rate of the gas turbine when the spray rate corresponds to a saturation limit of steam in the heat recovery steam generator.

4. The combined cycle power plant of claim 3, wherein the control system communicates with an attemperator controller to modify the spray rate in the attemperator in accordance with the modified heat rate set by the fuel controller.

5. The combined cycle power plant of claim 1, further comprising a fuel controller that controls an amount of fuel provided to the gas turbine, in order to adjust the exhaust gas temperature, the control system configured to automatically configure the fuel controller to modify the amount of fuel provided to the gas turbine when a detected spray rate corresponds to a saturation limit of steam in the heat recovery steam generator.

6. The combined cycle power plant of claim 1, wherein the control system is configured to set the heat rate of the combined cycle power plant based on a selection from within at least one of a specified range of gas turbine operational limits and a specified range of power plant operational limits, the at least one of the specified range of gas turbine operational limits and the specified range of power plant operational limits specified at least in part, on the basis of a range of loading conditions of the combined cycle power plant, the range of loading conditions extending from a full load condition to a full turndown condition.

7. A method of operating a combined cycle power plant, comprising:
detecting a first spray rate of a fluid in an attemperator when the combined cycle power plant is operating under a full load condition;
operating a control system to set a first heat rate of the combined cycle power plant in accordance with the first spray rate, the first heat rate and the first spray rate allowing the combined cycle power plant to operate in the full load condition and within operating specifications of the combined cycle power plant;
detecting a second spray rate of the fluid in the attemperator when the combined cycle power plant is operating under a full turndown condition; and
operating the control system to automatically change the first heat rate of the combined cycle power plant to at least a second heat rate, the second heat rate and the second spray rate allowing the combined cycle power plant to operate in the full turndown condition and within operating specifications of the combined cycle power plant.

8. The method of claim 7, wherein the control system is configured to operate in a real-time mode when setting the first heat rate and when changing the first heat rate to the second heat rate.

9. The method of claim 7, wherein the second spray rate corresponds to a degree of superheat above a saturation limit of steam in the attemperator, and wherein a combination of the first heat rate and the second spray rate fails to satisfy operating specifications of the combined cycle power plant.

10. The method of claim 9, wherein the second spray rate constitutes a maximum capacity of the attemperator.

11. The method of claim 7, wherein a combination of the second heat rate and the first spray rate is improper for operating the attemperator in accordance with the operating specifications of the combined cycle power plant.

12. The method of claim 7, wherein the combined cycle power plant comprises a gas turbine and a heat recovery steam generator, and wherein operating the control system to automatically change the first heat rate of the combined cycle power plant to the second heat rate comprises adjusting a rate of fuel provided to the gas turbine or operating one or more compressor extraction valves.

13. The method of claim 7, wherein the combined cycle power plant comprises a gas turbine and a heat recovery steam generator, and wherein the method further comprises:
measuring a first temperature at an exhaust port of the heat recovery steam generator; and
computing the second heat rate in the control system based at least in part, on the measured first temperature.

14. The method of claim 7, wherein the combined cycle power plant comprises a gas turbine and a heat recovery steam generator that incorporates the attemperator, and wherein the method further comprises:
measuring at least one of an operating parameter of the gas turbine or an operating condition of the heat recovery steam generator; and
computing the second heat rate in the control system based at least in part on the at least one of the operating parameter of the gas turbine or the operating condition of the heat recovery steam generator.

15. A non-transitory computer-readable storage medium with instructions executable by at least one computer for performing operations comprising:
detecting a first spray rate of a fluid in an attemperator when a combined cycle power plant is operating under a full load condition;
operating a control system to set a first heat rate of the combined cycle power plant in accordance with the first spray rate, the first heat rate and the first spray rate allowing the combined cycle power plant to operate under the full load condition and within operating specifications of the combined cycle power plant;
detecting at least a second spray rate of the fluid in the attemperator when the combined cycle power plant is operating under a full turndown condition; and
operating the control system to automatically change the first heat rate of the combined cycle power plant to at least a second heat rate, the second heat rate and the second spray rate allowing the combined cycle power plant to operate under the full turndown condition and within operating specifications of the combined cycle power plant.

16. The non-transitory computer-readable storage medium of claim 15 with instructions executable by the at least one computer for performing operations comprising:
adjusting a rate of fuel provided to a gas turbine of the combined cycle power plant to automatically change the first heat rate of the combined cycle power plant to the second heat rate.

17. The non-transitory computer-readable storage medium of claim 15 with instructions executable by the at least one computer for performing operations comprising:
measuring a first temperature at an exhaust port of a heat recovery steam generator of the combined cycle power plant; and
computing the second heat rate in the control system based at least in part, on the measured first temperature.

18. The non-transitory computer-readable storage medium of claim 15 with instructions executable by the at least one computer for performing operations comprising:
measuring at least one of an operating parameter of a gas turbine or an operating condition of a heat recovery steam generator of the combined cycle power plant; and
computing the second heat rate in the control system, based at least in part on the at least one of the operating parameter of the gas turbine or the operating condition of the heat recovery steam generator.

19. The non-transitory computer-readable storage medium of claim 15 with instructions executable by the at least one computer for performing operations comprising:
preventing an operating condition of the combined cycle power plant wherein a combination of the first heat rate and the second spray rate is used.

20. The non-transitory computer-readable storage medium of claim 15 with instructions executable by the at least one computer for performing operations comprising:
preventing an operating condition of the combined cycle power plant wherein a combination of the second heat rate and the first spray rate is used.
